(19) United States
(12) Patent Application Publication
(10) Pub. No.: US 2019/0291803 A1
(43) Pub. Date: Sep. 26, 2019

(54) SISSY BAR BRACKET EXTENSION AND SYSTEM

(71) Applicant: Randall W. Hart, Yorktown, VA (US)

(72) Inventor: Randall W. Hart, Yorktown, VA (US)

(21) Appl. No.: 16/298,047

(22) Filed: Mar. 11, 2019

Related U.S. Application Data
(60) Provisional application No. 62/645,836, filed on Mar. 21, 2018.

(51) Int. Cl. B62J 1/28; B62J 11/00

(52) U.S. Cl. CPC B62J 1/28; B62J 11/00

(57) ABSTRACT

A sissy bar bracket extension includes a U-shaped portion having a first leg, a second leg, and a third leg. The first leg is adapted to fit in a sleeve of a sissy bar bracket, the second leg is parallel to the first leg, and the third leg couples one end of the first leg to one end of the second leg. The three legs lie along a common axial plane. The first leg has two spaced-apart holes that are transverse to the common axial plane and that align with two mounting holes in the sleeve of the sissy bar bracket. An open-ended sleeve is rigidly coupled to the third leg and is aligned therewith along the common axial plane. The open-ended sleeve is adapted to receive a leg of a sissy bar.

Pursuant to 35 U.S.C. § 119, the benefit of priority from provisional application 62/645,836, with a filing date of Mar. 21, 2018, is claimed for this non-provisional application.

### FIELD OF THE INVENTION

The invention relates generally to sissy bars, and more particularly to a bracket extension for a sissy bar that creates more seating space for a motorcycle passenger.

### BACKGROUND OF THE INVENTION

A “sissy bar” is essentially a backrest mounted behind a motorcycle's seat. Since the driver of a motorcycle generally sits upright or leans forward as they hold onto a motorcycle's handle bars, a sissy bar typically serves as a backrest for a motorcycle passenger.

Conventional sissy bars have two legs, each of which is supported and attached to a bracket affixed to a motorcycle's rear fender. While this arrangement securely holds a sissy bar, it also fixes the sissy bar's position to define a fixed spacing for a motorcycle passenger between the back of a motorcycle driver and the sissy bar. Depending on the preferred positioning of a motorcycle driver, the size of a motorcycle driver, and/or the size of a motorcycle passenger, the fixed spacing between the back of a motorcycle driver and a sissy bar may be too small. If the spacing is too small, driver and/or the passenger comfort are affected. Furthermore, if the passenger spacing is not adequate, motorcycle safety becomes a concern when a motorcycle driver is forced to shift to a less-than-ideal driving position to improve the comfort of the motorcycle passenger.

### SUMMARY OF THE INVENTION

Accordingly, it is an object of the present invention to improve the comfort and safety of motorcycle travel for a motorcycle driver and a motorcycle passenger.

Another object of the present invention is to provide the means to adjust the position of a sissy bar.

Still another object of the present invention is to provide a safe and secure means to quickly and simply adjust the position of a sissy bar.

Other objects and advantages of the present invention will become more obvious hereinafter in the specification and drawings.

In accordance with the present invention, a sissy bar bracket extension includes a U-shaped portion having a first leg, a second leg, and a third leg. The first leg is adapted to fit in a sleeve of a sissy bar bracket. The second leg is parallel to the first leg. The third leg couples one end of the first leg to one end of the second leg, wherein the first leg, second leg, and third leg lie along a common axial plane. The first leg has two spaced-apart holes that are transverse to the common axial plane and that align with two mounting holes in the sleeve of the sissy bar bracket. An open-ended sleeve is rigidly coupled to the third leg and is aligned therewith along the common axial plane. The open-ended sleeve is adapted to receive a leg of a sissy bar. The open-ended sleeve has at least two holes that are transverse to the common axial plane.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a perspective view of a prior art one-piece sissy bar bracket for attachment to a motorcycle fender;

FIG. 2 is a perspective view of a prior art two-piece sissy bar bracket for attachment to a motorcycle fender;

FIG. 3 is a perspective view of a sissy bar bracket extension in accordance with an embodiment of the present invention;

FIG. 4 is a perspective view of a sissy bar bracket extension in accordance with another embodiment of the present invention; and

FIG. 5 is a perspective view of a sissy bar bracket extension in accordance with yet another embodiment of the present invention.

### DETAILED DESCRIPTION OF THE INVENTION

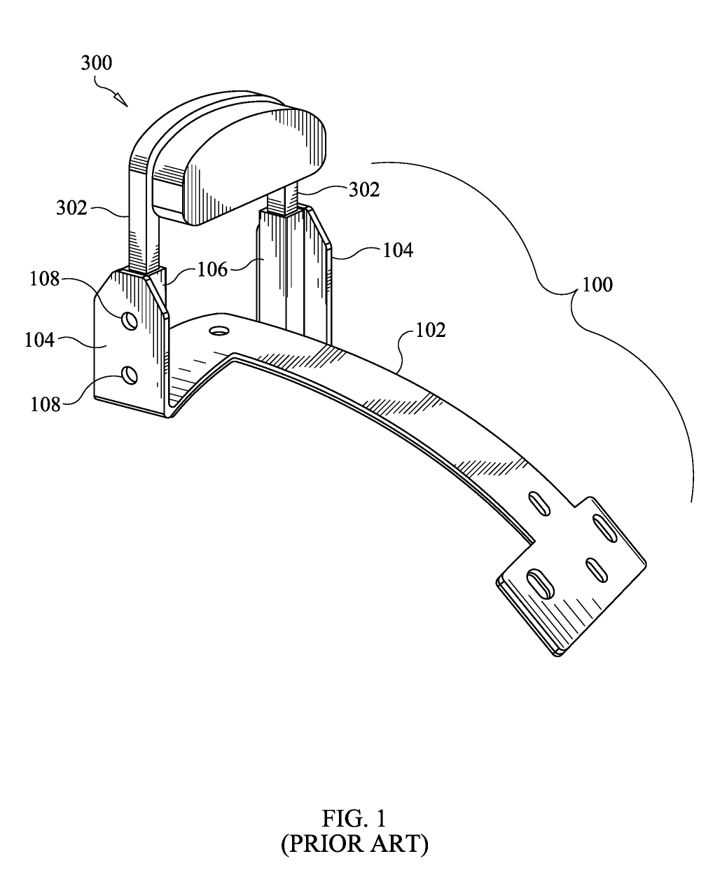

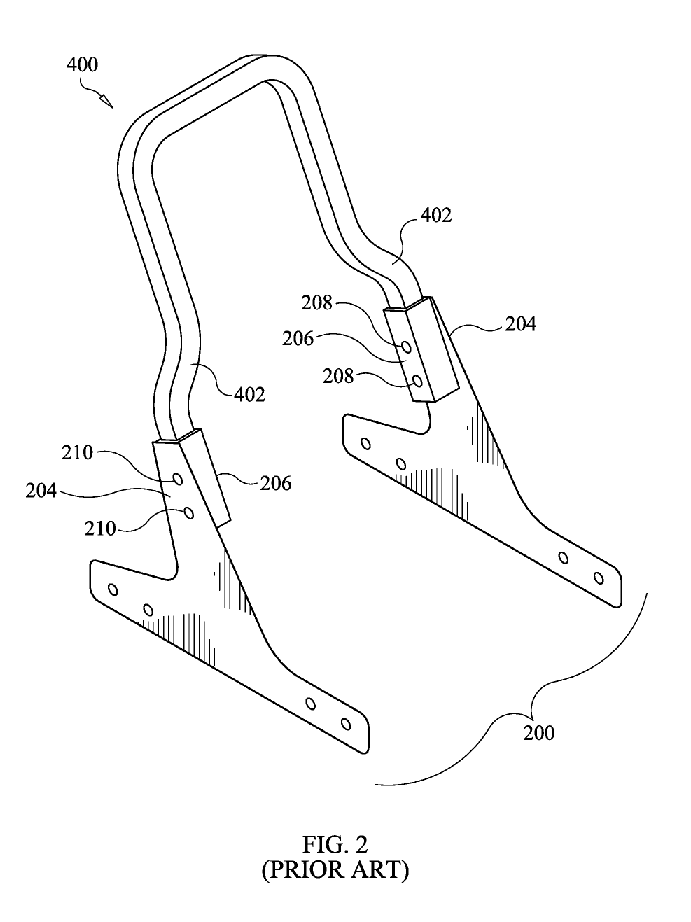

Prior to describing the present invention, reference will be made to FIGS. 1 and 2 where two prior art sissy bar brackets are illustrated. Briefly, FIG. 1 illustrates a one-piece bracket 100 and FIG. 2 illustrates a two-piece bracket 200. Both brackets 100 and 200 are adapted to be attached to a motorcycle's rear fender (not shown) using screws, bolts, etc., as is well-understood in the art.

Bracket 100 has a rigid base 102 with opposing upwardly-extending arms 104. Each of arms 104 incorporates an open-top sleeve 106 that includes side holes 108 accessible from outside the confines of bracket 100. In use, the legs 302 of a sissy bar 300 fit into the open tops of sleeves 106 and are fixed in place using screws/bolts (not shown) passing through holes 108 for engagement with and/or through legs 302. Bracket 200 has two separate rigid arms 204, each of which has an open-top sleeve 206 rigidly coupled thereto. Each sleeve includes side holes 208. In use, the legs 402 of a sissy bar 400 fit into the open-tops of sleeves 206 and are fixed in place using screws/bolts (not shown) passing through holes 208. For some sissy bar brackets, corresponding holes 210 are provided in arms 204 such that a bolt (not shown) can extend through a corresponding arm 204, leg 402, and hole 208.

The present invention can be used with either of the above-described sissy bar brackets, or other designs of sissy bar brackets that include sleeves for the receipt and fixing of the legs of a sissy bar. The present invention cooperates with such existing/installed sissy bar brackets to effectively re-position a sissy bar further towards the aft end of a motorcycle thereby giving a motorcycle driver and passenger more room, or further towards the front end of a motorcycle thereby reducing the space between a motorcycle driver and a sissy bar. The present invention provides this improvement while maintaining the strength and integrity of support for a sissy bar. Furthermore, the present invention provides a safe and secure bracket extension for the simple and quick re-positioning of a motorcycle's sissy bar to improve the comfort and safety of a motorcycle's driver and passenger.

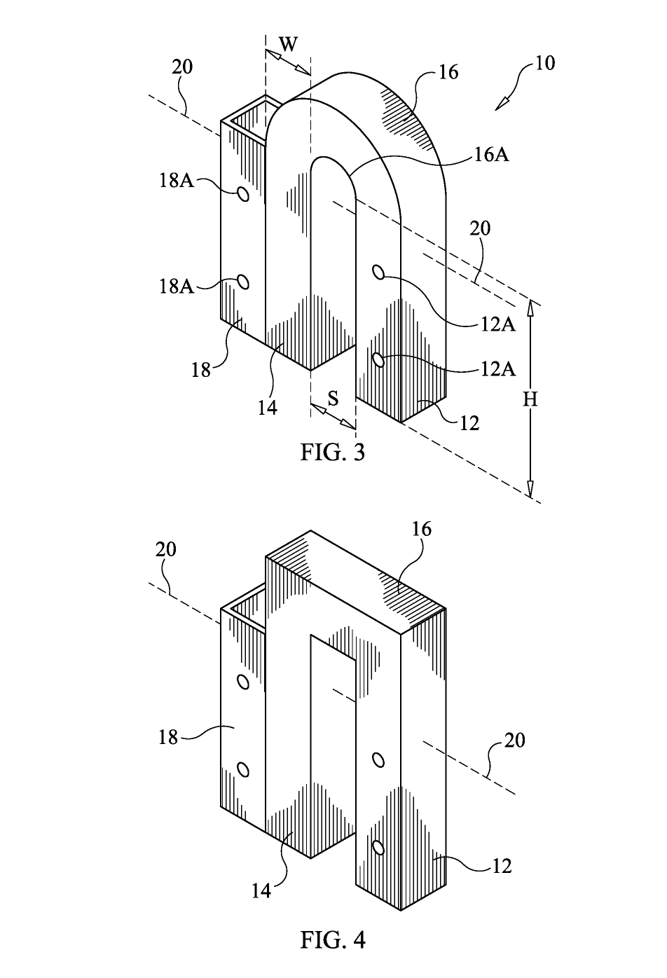

Referring additionally now to FIG. 3, a sissy bar bracket extension in accordance with an embodiment of the present invention is shown and is referenced generally by numeral 10. It is to be understood that two of bracket extension 10 define a bracket extension system to be used with an existing sissy bar bracket having two sissy-bar-leg-receiving sleeves (e.g., sleeves 106 or 206) as described above. Since the two bracket extensions will be identical, it is sufficient to show and describe a single bracket extension 10 in order to provide an understanding of the present invention.

Bracket extension 10 includes a front leg 12, a rear leg 14 that is generally parallel to front leg 12, a coupling leg 16 that rigidly couples the top of front leg 12 to the top of rear leg 14, and a sissy bar sleeve 18 rigidly coupled to or integrated with rear leg 14. Front leg 12, rear leg 14, and coupling leg 16 define a U-shaped portion of extension bracket 10 with the center portions of legs 12, 14 and 16 being aligned along a common axial plane indicated in the figure by dashed line 20. The spacing “S” between legs 12 and 14 combined with the width “W” of leg 14 (i.e., S+W) defines the amount of position adjustment provided by extension bracket 10.

In general, the entirety of bracket extension 10 is a rigid structure that can be made of metal, high-strength composites, or combinations thereof without departing from the scope of the present invention. Bracket extension 10 could be molded, cast, or otherwise constructed as a single integrated body, or could be assembled/welded to form its rigid structure without departing from the scope of the present invention. Front leg 12 is generally square in cross-section and is sized to fit or be indexed within the sissy-bar-leg-receiving-sleeve (e.g., sleeve 106 or 206) of an existing sissy bar bracket described previously herein. The shape of rear leg 14 and coupling leg 16 could be square in cross-section, but could also assume other geometries without departing from the scope of the present invention.

By way of an exemplary embodiment, front leg 12, rear leg 14, and coupling leg 16 are formed by a single piece of solid metal, while sissy bar sleeve 18 is a four-sided, open-ended sleeve that is rigidly coupled to or integrated with rear leg 14 such that the entirety of bracket extension 10 is rigid. The solid and integrated construction of front leg 12, rear leg 14, and coupling leg 16 provides a strong and secure base for sleeve 18. Coupling leg 16 can be curved (as shown) between the ends of front leg 12 and rear leg 14.

Front leg 12 includes two through-holes 12A spaced-apart in accordance with the standard spacing found on sissy bar bracket sleeves such as the above-described sleeves 106 and 206. Holes 12A are transverse with respect to common axial plane 20 of bracket extension 10. The height “H” of front leg 12 must be long enough to allow holes 12A to be aligned with the holes (e.g., holes 108/208) in an existing sissy bar bracket sleeve. In one embodiment of the present invention, height H is selected such that holes 12A will automatically align with the holes (e.g., holes 108 or 208) in an existing sissy bar bracket sleeve when the bottom portion 16A of coupling leg 16 engages the open top of a sissy bar bracket sleeve. In this way, the existing sissy bar bracket provides vertical support for bracket extension 10 and the screws/bolts (not shown) cooperating with the aligned holes (e.g., holes 12A and holes 108 or 208) secure bracket extension 10 to the existing sissy bar bracket. Holes 12A can be threaded or non-threaded without departing from the scope of the present invention.

Sissy bar sleeve 18 is also centrally aligned with legs 12 and 14 along common axial plane 20, and is rigidly coupled to or integrated with rear leg 14. Sleeve 18 can be sized/shaped to receive and form an index fit with a sissy bar's leg. Sleeve 18 includes two through-holes 18A spaced-apart in accordance with the standard spacing found on the above-described sissy bar bracket sleeves 106 and 206, i.e., holes 18A are spaced apart from one another by the same amount as holes 12A. Holes 18A are transverse to common axial plane 20.

In use, two of bracket extensions 10 are employed with an existing sissy bar bracket. The front leg 12 of each such bracket extension is positioned in a sleeve (e.g., sleeve 106 or 206) of a sissy bar bracket and is attached thereto using bolts/screws. Since each front leg 12 is indexed to a sleeve 106 or 206, and since each sissy bar sleeve 18 is aligned with its bracket extension's common axial plane 20, sleeves 18 of two so-installed bracket extensions 10 will be perfectly aligned to receive the legs of a sissy bar (not shown in FIG. 3). The sissy bar is then readily attached to sleeves 18 using screws/bolts cooperating with holes 18A and the sissy bar's legs.

The present invention is not limited to the particular embodiment just described. For example, FIG. 4 illustrates another embodiment of the present invention in which coupling leg 16 is a straight beam section rigidly coupling front leg 12 and rear leg 14. More generally, coupling leg 16 could be realized by a variety of shapes so long as front leg 12, rear leg 14, and sleeve 18 are centrally aligned along common axial plane 20.

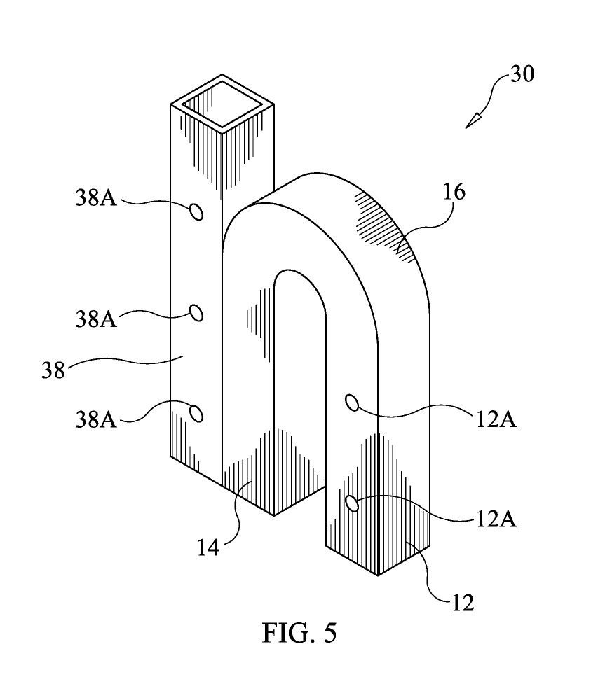

In yet another embodiment of the present invention, FIG. 5 illustrates a sissy bar bracket extension 30 whose sissy bar sleeve 38 is lengthened to accommodate at least one extra through-hole 38A with spacing between any two adjacent holes 38A being commensurate with the standard spacing found on existing sissy bar bracket sleeves such as the above-described sleeves 106 and 206, i.e., adjacent ones of holes 38A are spaced apart from one another by the same amount as holes 12A. In this way, a user could be provided with a height adjustment option when attaching a sissy bar to the sissy bar bracket extension.

The advantages of the present invention are numerous. The rigid sissy bar bracket extension provides a simple, quick, and robust means to reposition a motorcycle's sissy bar for improved comfort and safety of a motorcycle driver and passenger. The bracket extension will work with a variety of existing sissy bar brackets to provide a simple solution to a common problem experienced by motorcycle owners and passengers.

Although the invention has been described relative to specific embodiments thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A sissy bar bracket extension, comprising:
a U-shaped portion having a first leg, a second leg, and a third leg;
said first leg adapted to fit in a sleeve of a sissy bar bracket;
said second leg being parallel to said first leg;
said third leg coupling one end of said first leg to one end of said second leg, wherein said first leg, said second leg, and said third leg lie along a common axial plane;
said first leg having two spaced-apart holes transverse to said common axial plane and adapted to align with two mounting holes in the sleeve of the sissy bar bracket; and
an open-ended sleeve rigidly coupled to said third leg and aligned therewith along said common axial plane, said open-ended sleeve adapted to receive a leg of a sissy bar, said open-ended sleeve having at least two holes transverse to said common axial plane.

2. A sissy bar bracket extension as in claim 1, wherein said U-shaped portion is solid throughout said first leg, said second leg, and said third leg.

3. A sissy bar extension as in claim 1, wherein said U-shaped portion comprises a single integrated element.

4. A sissy bar extension as in claim 1, wherein said first leg, said second leg, and said third leg are square in cross-section.

5. A sissy bar extension as in claim 1, wherein said first leg is shaped for an indexed fit in the sleeve of the sissy bar bracket.

6. A sissy bar extension as in claim 1, wherein said open-ended sleeve is square in cross-section.

7. A sissy bar extension as in claim 1, wherein said open-ended sleeve is shaped for an indexed fit with the leg of the sissy bar.

8. A sissy bar extension as in claim 1, wherein said third leg is curved.

9. A sissy bar extension as in claim 1, wherein said third leg is straight.

10. A sissy bar extension as in claim 1, wherein said first leg and said third leg are adapted to cooperate with the sleeve of the sissy bar bracket to automatically align said two spaced-apart holes in said first leg with the two mounting holes in the sleeve of the sissy bar bracket when said first leg is positioned in the sleeve of the sissy bar bracket.

11. A sissy bar bracket extension system, comprising two bracket extensions, each of said bracket extensions having
a U-shaped portion having a first leg, a second leg, and a third leg,
said first leg adapted to fit in a sleeve of a sissy bar bracket,
said second leg being parallel to said first leg,
said third leg coupling one end of said first leg to one end of said second leg, wherein said first leg, said second leg, and said third leg lie along a common axial plane,
said first leg having two spaced-apart holes transverse to said common axial plane and adapted to align with two mounting holes in the sleeve of the sissy bar bracket, and
an open-ended sleeve rigidly coupled to said third leg and aligned therewith along said common axial plane, said open-ended sleeve adapted to receive a leg of a sissy bar, said open-ended sleeve having at least two holes transverse to said common axial plane.

12. A system as in claim 11, wherein said U-shaped portion is solid throughout said first leg, said second leg, and said third leg.

13. A system as in claim 11, wherein said U-shaped portion comprises a single integrated element.

14. A system as in claim 11, wherein said first leg, said second leg, and said third leg are square in cross-section.

15. A system as in claim 11, wherein said first leg is shaped for an indexed fit in the sleeve of the sissy bar bracket.

16. A system as in claim 11, wherein said open-ended sleeve is square in cross-section.

17. A system as in claim 11, wherein said open-ended sleeve is shaped for an indexed fit with the leg of the sissy bar.

18. A system as in claim 11, wherein said third leg is curved.

19. A system as in claim 11, wherein said third leg is straight.

20. A system as in claim 11, wherein said first leg and said third leg are adapted to cooperate with the sleeve of the sissy bar bracket to automatically align said two spaced-apart holes in said first leg with the two mounting holes in the sleeve of the sissy bar bracket when said first leg is positioned in the sleeve of the sissy bar bracket.
